(19) United States
(12) Patent Application Publication
(10) Pub. No.: US 2026/0095844 A1
(43) Pub. Date: Apr. 2, 2026

(54) SYSTEM AND METHOD FOR DYNAMIC MODIFICATION OF MOBILE-INITIATED CONNECTION ONLY MODE

(71) Applicant: Verizon Patent and Licensing Inc., Basking Ridge, NJ (US)

(72) Inventors: Suzann Hua, Beverly Hills, CA (US); Ye Huang, San Ramon, CA (US); Chien-Yuan Huang, Basking Ridge, NJ (US); Helen Osias Eglip, Sammamish, WA (US)

(21) Appl. No.: 18/899,487

(22) Filed: Sep. 27, 2024

(51) Int. Cl. H04W 48/16; H04W 4/14

(52) U.S. Cl. CPC H04W 48/16; H04W 4/14

(57) ABSTRACT

A system may include a network component. The network component may be configured to: send, to a core network component, a request to modify a Mobile-Initiated Connection Only (MICO) parameter value stored at a network; receive, from the core network component, a reply that includes an indication regarding whether the MICO parameter value, of a User Equipment device (UE), has been modified in accordance with the request; and send a message that includes the indication.

### BACKGROUND INFORMATION

Many advanced wireless networks support devices that are capable of operating in Mobile-Initiated Connection Only (MICO) mode. MICO mode is used in scenarios where a device seldom needs to communicate with the network and has no need to have the network initiate communication. MICO mode is especially relevant to Internet-of-Things (IoT) devices that require extended battery life.

When in MICO mode, the mobile device can initiate a connection to the network when the device has data to send or to perform an action. However, the network cannot initiate a connection to the device. This is different from the default mode where the network and device can both initiate connections. By allowing only the mobile device to initiate connections, MICO mode can significantly reduce device power consumption.

### BRIEF DESCRIPTION OF THE DRAWINGS

FIG. 1 illustrates concepts described herein.

FIG. 2 illustrates an exemplary network environment in which systems and methods described herein may be implemented.

FIG. 3 depicts exemplary Fifth Generation (5G) core network components, according to an implementation.

FIG. 4 shows example records that may be maintained by various components of a system for dynamic modification of Mobile Initiated Communication Only (MICO) mode of User Equipment devices (UEs), according to an implementation.

FIG. 5 is a flow diagram of an example process that may be performed by components of a system for dynamic modification of MICO mode of UEs, according to an implementation.

FIG. 6 illustrates example messages that may be exchanged by components of a system for dynamic modification of MICO mode of UEs, according to an implementation.

FIG. 7 depicts exemplary functional components of a network device according to an implementation.

### DETAILED DESCRIPTION

The following detailed description refers to the accompanying drawings. The same reference numbers in different drawings may identify the same or similar elements. As used herein, the terms “service provider” and “provider network” may refer to, respectively, a provider of communication services and a network operated by the service provider. The network may be a cellular network. A cellular network may be uniquely identified by a Public Land Mobile Network (PLMN) Identifier (ID).

Systems and methods described herein relate to network support for User Equipment devices (UEs) to switch from Mobile Initiated Connection Only (MICO) mode to non-MICO mode. MICO mode is a mode of operation for UEs in many advanced networks, such as Fifth Generation (5G) networks and some types of 4G networks. When a MICO activated UE is in an idle state, the network considers the UE to be unreachable. Thus, the UE may receive Mobile Terminated (MT) data only when the UE transitions to a connected state. This transition to the connected state while in MICO mode may be triggered by the UE. The network may not page the UE while the UE is operating in MICO mode. The network is aware when the UE is in MICO mode and thus adheres to network-side requirements that are associated with MICO mode. Hence, in a sense, with respect to a UE that is in MICO mode, the network also operates in MICO mode.

MICO mode is designed for Internet-of-Things (IoT) devices that send data but do not need to be paged. An example of such a device is a smart sensor that sends monitored parameter values to an application server via the network (e.g., temperature, flow rate, water level, pressure, etc.). In response, the application server may take certain actions, such as issuing commands to a control system, alerting system operators, etc.

Typically, a UE may operate in MICO mode in accordance with static MICO parameters values stored at the provider network. However, in many use-case scenarios that involve IoT device deployment, there is a need for the flexibility for a UE to dynamically switch from MICO mode to non-MICO mode. Systems and methods described herein implement mechanisms for dynamic modifications of MICO mode of UEs or the MICO parameters of UEs.

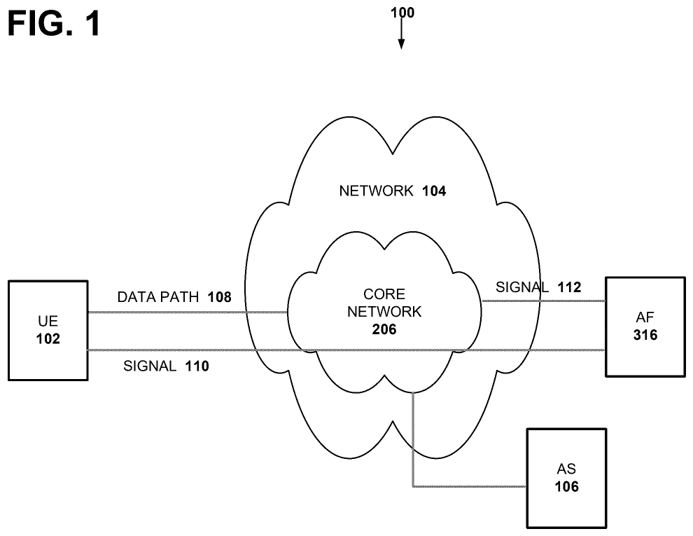

FIG. 1 illustrates concepts described herein. As shown, system 100 includes a UE 102, a network 104 which in turn includes a core network 206, an application server 106, and a third-party application function (AF) 316. Assume that UE 102 is a MICO device (e.g., a sensor device that collects data from its environment) operating in MICO mode; and that network 104 is aware that UE 102 is in MICO mode and of the times at which UE 102 is likely connect to network 104. Furthermore, assume that UE 102 connects to provider network 104, to establish a session with application server (AS) 106 (e.g., to connect to upload data that UE 102 has collected, to interact with AS 106, etc.). UE 102 may then communicate with AS 106 over data path 108.

Assume that a triggering event has occurred at either UE 102, AS 106, or AF 316. The triggering event may include the onset of conditions under which network-initiated communications may be desirable and thus supersedes the power savings-oriented policy at UE 102. For example, if UE 102 is a sensor device that monitors wind speeds, a triggering event may include UE 102 detecting wind speeds above 150 miles-per-hour. After the detection of high speeds, it may be desirable for AS 106 (or AS to cause AF 316) to initiate communications with UE 102 and query UE 102 for wind speed measurements at times set by AS 106 (or by AF 316). In another example, a triggering event may include a network operator issuing a manual command to a network component (e.g., AF 316).

Upon detecting the triggering event, system 100 may cause UE 102 to exit MICO mode. In one implementation, for example, AS 106 may cause AF 316 to signal 112 core network 206 to modify values of MICO parameters of UE 102. After core network 206 modifies the MICO parameter values, core network 206 may notify UE 102 to exit MICO mode. In a different implementation, UE 102 itself may initiate an exit from MICO mode, by sending a request to AF 316 and causing AF 316 to signal core network 206. Thereafter, as described above, AF 316 may signal 112 core network 206 to modify values of MICO parameters of UE 102. Subsequently, AF 316 may notify UE 102 to exit MICO mode. In some implementations, when MICO mode-capable UE 102 is in non-MICO mode, UE 102 and/or AF 316 may initiate signaling that causes UE 102 and network 104 to enter MICO mode.

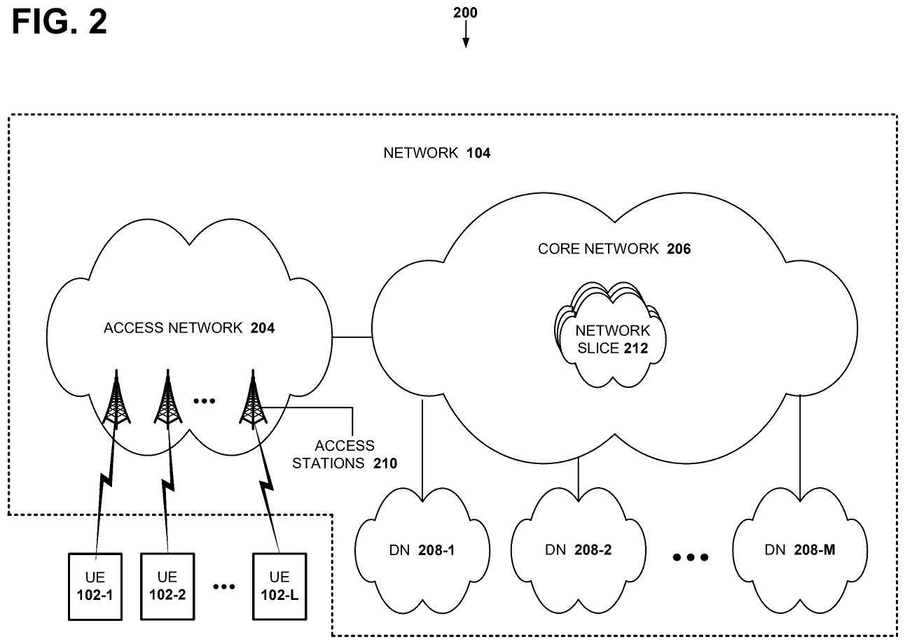

FIG. 2 illustrates an exemplary network environment 200 in which the systems and methods described herein may be implemented. As shown, network environment 200 may include UEs 102-1 through 102-L (collectively referred to as UEs 102 and generically referred to as UE 102), access network 204, core network 206, and data networks (DNs) 208-1 through 208-M (collectively referred to as data networks (DNs) 208 and generically as data network (DN) 208). Access network 204, core network 206, and data networks 208 may be part of provider network 104.

UEs 102 may include devices capable of MICO mode communication and non-MICO mode communication. In addition, UEs 102 may be capable of Fourth Generation (4G) (e.g., Long-Term Evolution (LTE)) communication, Fifth Generation (5G) New Radio (NR) communication, and/or other wireless communication. Examples of UE 102 include: IoT devices, such as sensors (e.g., temperature, humidity, water levels, chemical compounds, etc.); smart meters (e.g., water, gas, electricity, etc.); wearables (e.g., fitness trackers); asset trackers (e.g., vehicles, goods, etc.); Narrow Band (NB)-IoT devices; LTE Cat-M1 devices; smart home devices (e.g., security cameras); industrial IoT devices (e.g., monitoring devices); medical devices (e.g., patient monitoring devices); agricultural devices (e.g., livestock trackers); and fleet management devices (e.g., vehicle telematics). Additional examples of UEs 102 include: a Fixed Wireless Access (FWA) device; a Customer Premises Equipment (CPE) device with 4G and 5G capabilities; a smart phone; a tablet device; a smart watch; a global positioning system (GPS) device; a laptop computer; a media playing device; a portable gaming system; and an autonomous vehicle navigation system. In some implementations, UE 102 may include a wireless Machine-Type-Communication (MTC) device that communicates with other devices over a machine-to-machine (M2M) interface, such as LTE-M or CAT-M1 devices and NB-IoT devices.

UEs 102 may be associated with a user that is subscribed to network 104 to receive various services. UE 102 may operate in accordance with a service profile or a subscription profile stored at network 104. UE 102 may operate in MICO mode, in either the idle state or the connected state. When UE 102 is in the idle state, UE 102 may not accept paging requests from network 104; and when UE 102 is in the connected state, UE 102 may initiate communications with network 104, to establish a session, for example. In some implementations, during its communications with network 104, UE 102 in MICO mode may employ Discontinuous Reception (DRX).

UE 102 may be capable of switching from MICO mode to non-MICO mode and vice versa. Such UE 102 may also include mechanisms for detecting a triggering event (e.g., a user input or a change in its environment). Upon detecting a triggering event, UE 102 may send a request (e.g., Short Messaging Service (SMS) message) to AF 316 in network 104 to change the network settings for UE 102 and network 104 to operate in MICO mode or UE 102 and network 104 to operate in non-MICO mode. The settings may include, for example, MICO parameters (e.g., schedule, DRX parameters, etc.), an indication of whether UE 102 is currently operating in MICO mode, and an indication of whether UE 102 is authorized to change its MICO parameter values. When UE 102 receives communications from AF 316, indicating that MICO parameters for UE 102 have been changed, UE 102 may exit MICO mode, enter MICO mode, or modify its connection-related behavior consistent with the changes in MICO parameters values (e.g., schedule change).

Access network 204 may facilitate UE 102's connection to core network 206 by establishing and managing over-the-air channels with UE 102 and backhaul channels with core network 206. These channels enable the relay of information between UE 102 and core network 206. Access network 204 comprises LTE, 5G NR, or other advanced radio access networks, featuring components such as central units (CUs), distributed units (DUs), radio units (RUs), and/or base stations. These network components are illustrated in FIG. 2 as access stations 210 (herein generically referred to as access station 210) for establishing and maintaining over-the-air channel with UEs 102. In some implementations, access station 210 may include a 4G, 5G, or another type of base station (e.g., evolved Node B (eNB), next generation Node B (gNB), etc.) that comprises one or more radio frequency (RF) transceivers. In some implementations, access station 210 may be part of an evolved Universal Mobile Telecommunications Service (UMTS) Terrestrial Radio Access Network (eUTRAN).

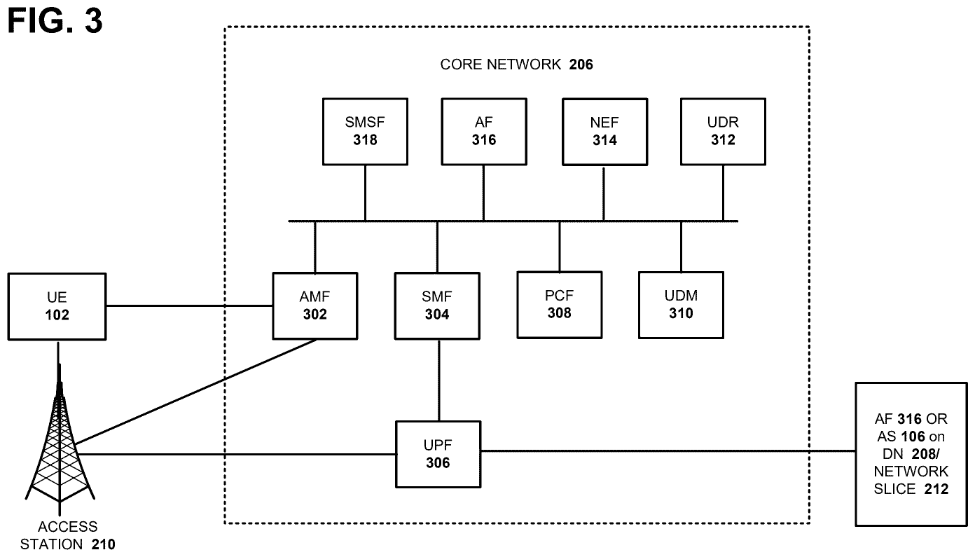

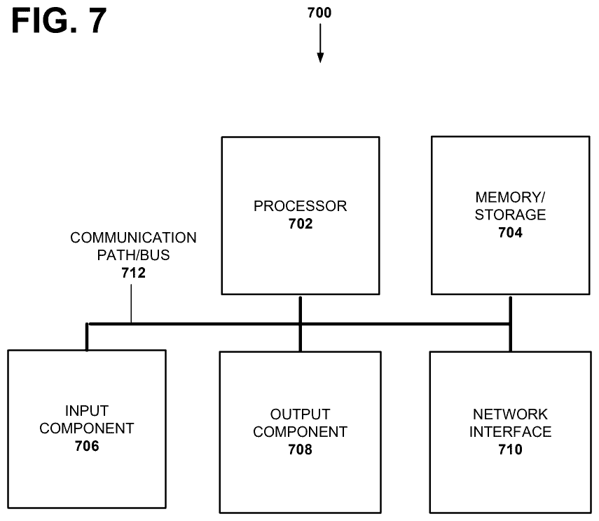

Core network 206 may oversee communication sessions for subscribers connecting via access network 204. For instance, core network 206 may facilitate the establishment of Internet Protocol (IP) connections between UEs 102 and data networks 208. The components within core network 206 can be either dedicated hardware elements or virtualized functions operating atop a shared physical infrastructure using Software Defined Networking (SDN). An SDN controller, for example, may leverage an adapter to implement one or more core network components through virtualized entities like virtual network functions (VNF) virtual machines, Cloud Native Function (CNF) containers, event-driven serverless architecture interfaces, or other SDN components. This shared physical infrastructure may include devices 700, as described below with reference to FIG. 7, within a cloud computing center associated with core network 206. Moreover, core network 206 may encompass 5G core network components, 4G core network components, or other types of core components. Further elaboration on some of these components is provided below with reference to FIG. 3.

As further shown, core network 206 may include one or more network slices 212. Depending on the embodiment, network slices 212 may be implemented within other networks, such as access network 204 and/or data network 208. Access network 204, core network 206, and data networks 208 may include multiple instances of network slices 212 (generically or individually referred to as network slice 212). Each network slice 212 may be instantiated as a result of “network slicing,” which involves a form of virtual network architecture that enables multiple logical networks to be implemented on top of a shared physical network infrastructure using SDN and/or network function virtualization (NFV). Each logical network, referred to as a “network slice,” may encompass an end-to-end virtual network with dedicated storage and/or computational resources that include access network components, clouds, transport network components, Central Processing Unit (CPU) cycles, memory, etc. Furthermore, each network slice 212 may be configured to meet a different set of requirements and may be associated with a particular QoS Class Identifier (QCI), a type of service, a 5G QoS Identifier (5QI), and/or a particular group of enterprise customers associated with communication devices. Network slices 212 may be capable of supporting enhanced Mobile Broadband (eMBB) traffic, Ultra Reliable Low Latency Communication (URLLC) traffic, Time Sensitive Network (TSN) traffic, Massive IoT (MIoT) traffic, Vehicle-to-Everything (V2X) traffic, High performance Machine Type Communication (HMTC) traffic, and other customized traffic, for example.

Each network slice 212 may be associated with an identifier, herein referred to as a Single Network Slice Selection Assistance Information (S-NSSAI) and/or a network slice instance ID. Each UE 102 that is configured to access a particular network slice 212 may be associated with corresponding data, stored in core network 206 for example, which includes the S-NSSAI that identifies the network slice 212.

Data networks 208 may include one or more networks connected to core network 206. In some implementations, a particular data network 208 may be associated with a data network name (DNN) in 5G and/or an Access Point Name (APN) in 4G. UE 102 may request a connection to data network 208 using a DNN or APN. In a 5G network, data network 208 that is implemented on network slice 212 may nonetheless be associated with a DNN. Each data network 208 may include, and/or be connected to and enable communications with, a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, and/or an LTE network), an ad hoc network, a telephone network (e.g., the Public Switched Telephone Network (PSTN) or a cellular network), an intranet, or a combination of networks. Data network 208 may include an AS (also referred to as application), such as AS 106 illustrated in FIG. 1. An application may render services to other applications running on UEs 102 and may establish communication sessions with UEs 102 via core network 206.

For clarity, FIG. 2 does not show all components that may be included in network environment 200 (e.g., routers, bridges, wireless access points, additional networks, additional access stations 210, data centers, portals, etc.). Depending on the implementation, network environment 200 may include additional, fewer, different, or a different arrangement of components than those illustrated in FIG. 2.

FIG. 3 depicts exemplary 5G core network components 302—in core network 206 according to an implementation. As indicated above, one or more of core network components (e.g., components 302-318), in conjunction with other network components, may implement systems and methods for dynamic modification of MICO mode or MICO-mode parameter values. As shown, core network 206 may include an Access and Mobility Management Function (AMF) 302, a Session Management Function (SMF) 304, a User Plane Function (UPF) 306, a Policy Control Function (PCF) 308, a Unified Data Management (UDM) 310, a Unified Data Repository (UDR) 312, a Network Exposure Function (NEF) 314, an AF 316, and a Short Message Service Function (SMSF) 318,

Although FIG. 3 shows core network 206 as including 5G core network components 302-318, in practice, core network 206 may include additional, fewer, and/or different core network components than those illustrated in FIG. 3. For example, core network 206 may include 4G core network components (e.g., a Mobility Management Entity (MME), a Serving Gateway (SGW), a Packet Data Network Gateway (PGW), a Policy and Charging Rules Function (PCRF), a Home Subscriber Server (HSS), a Service Capability Exposure Function (SCEF), an and AS). In another example, core network 206 may include an Authentication Server Function (AUSF), a Charging Function (CHF), a Network Slice Selection Function (NSSF), a Network Repository Function (NRF), a Network Data Analytics Function (NWDAF), etc.

AMF 302 may perform registration management, connection management, reachability management, mobility management, lawful intercepts, SMS transport between UE 102 and SMSF 318, session management messages transport between UE 102 and SMF 304, access authentication and authorization, location services management, functionality to support non-Third Generation Partnership Program (3GPP) access networks, and/or other types of management processes.

When AMF 302 receives SMS messages for AF 316 from UE 10 via access network 204, AMF 302 may pass the SMS messages to SMSF 318. Conversely, when AMF 302 receives an SMS reply (e.g., an SMS message that originated from AF 316) via SMSF 318, AMF 302 may forward the SMS reply to UE 102.

SMF 304 may perform session establishment, session modification, and/or session release, perform IP address allocation and management, perform Dynamic Host Configuration Protocol (DHCP) functions, perform selection and control of UPF 306, configure traffic steering at UPF 306 to guide the traffic to the correct destinations, terminate interfaces toward PCF 308, perform lawful intercepts, charge data collection, support charging interfaces, control and coordinate charging data collection, terminate session management parts of Non-Access Stratum (NAS) messaging, perform downlink data notification, manage roaming functionality, and/or perform other types of control plane processes for managing user plane data.

UPF 306 may maintain an anchor point for intra/inter-Radio Access Technology (RAT) mobility, maintain an external PDU point of interconnect to a particular data network (e.g., data network 208), perform packet routing and forwarding, perform the user plane part of policy rule enforcement, perform packet inspection, perform lawful intercept, perform traffic usage reporting, perform QoS handling in the user plane, perform uplink traffic verification, perform transport level packet marking, perform downlink packet buffering, forward an “end marker” to a RAN node (e.g., access station 210), and/or perform other types of user plane processes.

PCF 308 may support policies to control network behavior, provide policy rules to control plane functions (e.g., to AMF 302, SMF 304, etc.), access subscription information relevant to policy decisions, make policy decisions, and/or perform other types of processes associated with policy enforcement. As described above, when PCF 308 receives an SM Policy Association Create message from SMF 304, PCF 308 may provide a response that includes a session rules and one or more PCC rules.

UDM 310 may maintain subscription information for UEs 102, manage subscriptions, generate authentication credentials, handle user identification, perform access authorization based on subscription data, perform network function registration management, maintain service and/or session continuity by maintaining assignment of SMF 304 for ongoing sessions, support SMS delivery, support lawful intercept functionality, and/or perform other processes associated with managing user data. UDM 310 may store data that it manages in a UDR 312. UDR 312 may include subscription data associated with the subscribers of network services (e.g., users of UE 102), policy data, and application data. The policy data may include policy rules and parameters associated with the policy rules. The application data may comprise information and/or data collected by applications.

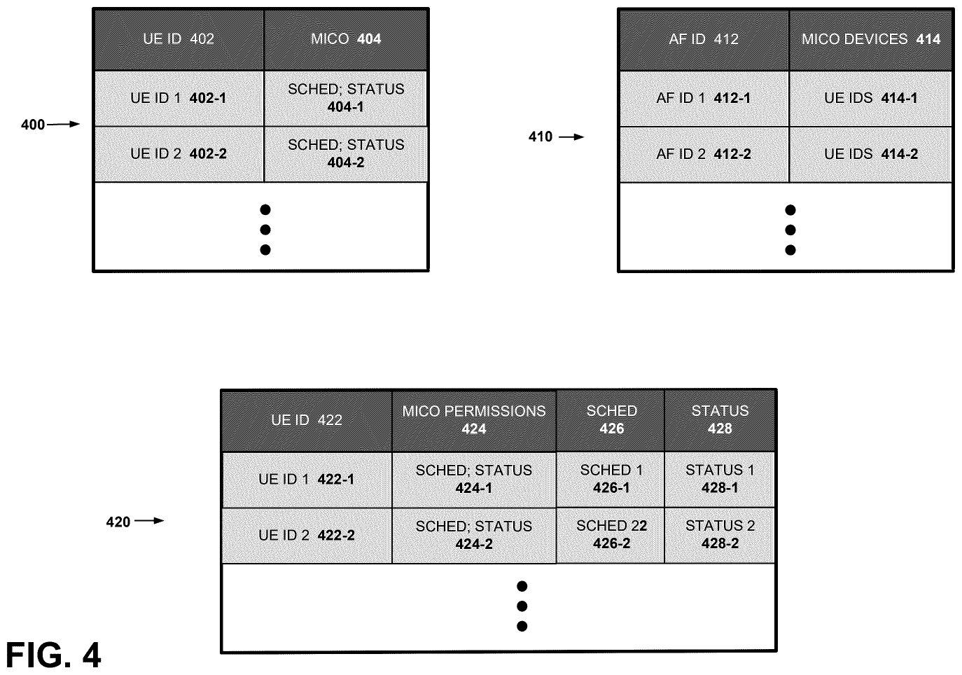

Subscription profiles (and/or service profiles) that UDR 312 stores may include MICO parameter values. When UDM 310/UDR 312 receives a request to change MICO parameter values from AF 316 via NEF 314, UDM 310/UDR 312 may check the permissions for AF 316 and/or UE 102 associated with the MICO parameters values. If the permissions indicate that the parameters values can be changed, UDM 310/UDR 312 may modify (or not modify) the MICO parameter values for UE 102 and issue a reply, indicating that the MICO parameter values have been changed (or not changed). MICO parameter values that are stored at UDR 312 are described below in greater detail with reference to FIG. 4.

NEF 314 may expose network services and capabilities to external applications or functions (e.g., external AF 316), such as third-party services, while ensuring security, authorization, and control. NEF 314 may allow external applications to interact with the 5G core components by providing application programming interfaces (APIs) for services, such as session management, location information, and policy control.

When NEF 314 receives a request from AF 316 to change MICO parameters values, NEF 314 may check its internal database to determine whether the requesting AF 316 is permitted to modify the MICO parameter values. If the requesting AF 316 has the permissions, NEF 314 may issue a MICO modification request (on behalf of AF 316) to UDM 310/UDR 312. When NEF 314 receives a reply that indicates whether the MICO parameters have been successfully modified, NEF 314 may forward the reply to AF 316.

AF 316 may include an external or internal application that interacts with the 5G core network components, to request specific services, such as managing QoS, accessing network capabilities, or sending/receiving data like SMS messages. AF 316 may operate in combination with NEF 314 to securely communicate with core network functions.

In one embodiment, AF 316 may send a request to modify MICO parameter values associated with UE 102 to UDM 310/UDR 312 via NEF 314. AF 316 may do so in response to detecting a triggering event or in response to a request from UE 102. When AF 316 receives a reply from UDM 310/UDR 312 (e.g., via NEF 316) indicating a result of the attempt to modify the MICO parameter values, AF 316 may send a notification to UE 102, when UE 102 is in the connected state. If UE 102 is in non-MICO mode, AF 316 may page UE 102 for the notification.

SMSF 318 may manage SMS message delivery. SMSF 318 may handle the control plane operations for SMS messages, ensuring that they are delivered from UE 102 to the network and vice versa. If an SMS message is to/from an external AF 316, SMSF 318 may forward the message via NEF 314.

FIG. 4 shows example records (or data) that may be maintained by various components of system 100 for dynamic modification of MICO mode of UEs 102. As shown, the records include AF MICO records 400, NEF MICO records 410, and UDR MICO records 420. Depending on the implementation, each of records 400, 410, and 420 may include additional, fewer, different, or differently arranged fields than those illustrated in FIG. 4.

As further shown, each of AF records 400 (maintained at AF 316) may include a UE identifier (ID) field 402 and MICO permissions field 404. Each UE ID field 402 (402-1, 402-2, . . . ) may include an UE identifier, such as a Mobile Station International Subscriber Directory Number, an International Mobile Subscriber Identity (IMSI), a Subscription Permanent Identifier (SUPI), etc. MICO permissions field 404 may indicate what MICO parameter values a particular UE 102 may request AF 316 to modify (on behalf of UE 102) or what MICO parameter values (of UE 102 identified by UE ID field 402) may be modified by AF 316. For example, MICO permissions field 404 may indicate whether, for particular UE 102, whether its MICO status may be modified, its MICO schedule may be modified, etc. A MICO schedule includes data that specifies when UE 102 is likely to connect to network 104 and AF 316 (or AS 106). For example, if MICO permissions field 404-1 indicates “YES” for the MICO status of UE 102, AF 316 may have the authority to request network 104 (on behalf or UE 102 or upon detecting a triggering event) to change UE 102's MICO mode or non-MICO mode.

NEF record 410 may include AF ID field 412 and MICO devices field 414. AF ID field 412 may include identifiers of AFs 316; and MICO devices field 414 may include IDs of UEs 102 whose MICO parameter values that AF 316 may request NEF 314 to modify. In some implementations, NEF records 410 may include only IDs of AFs 316 that are permitted to modify MICO parameter values and not include MICO devices field 414. When NEF 314 receives a request to modify MICO parameter values, NEF 314 may determine whether AF 316 has the authority for requesting the modification, using NEF MICO records 410.

UDR MICO records 420 may include a UE ID field 422, a MICO permissions field 424, and fields that specify MICO parameters values, such as schedule field 426 and status field 428. UE ID field 422 may identify UE 102 to which the particular record (e.g., record 420-1, record 420-2, etc.) pertains. UE ID field 422 may include identifiers such as an MSISDN, an IMSI, a SUPI, or another type of UE identifier. MICO permissions field 424 may include permissions for each of the MICO parameters values stored at UDR 312 (e.g., schedule, status, etc.). For example, MICO permissions field 424-1 may specify “NO” and “YES” for the permissions to change the schedule and the MICO mode, respectively. Schedule 426 may store the MICO schedule associated with UE 102. Status field 428 may indicate whether UE 102 specified by UE ID field 422 is currently in MICO mode or non-MICO mode. Depending on the implementation, MICO permissions field 424 may not include, for example, permissions for schedules or include additional permissions on other parameters, such as DRX parameters.

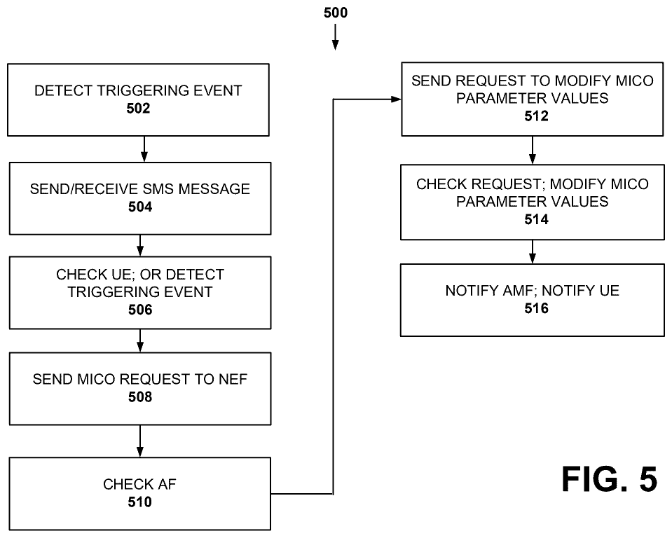

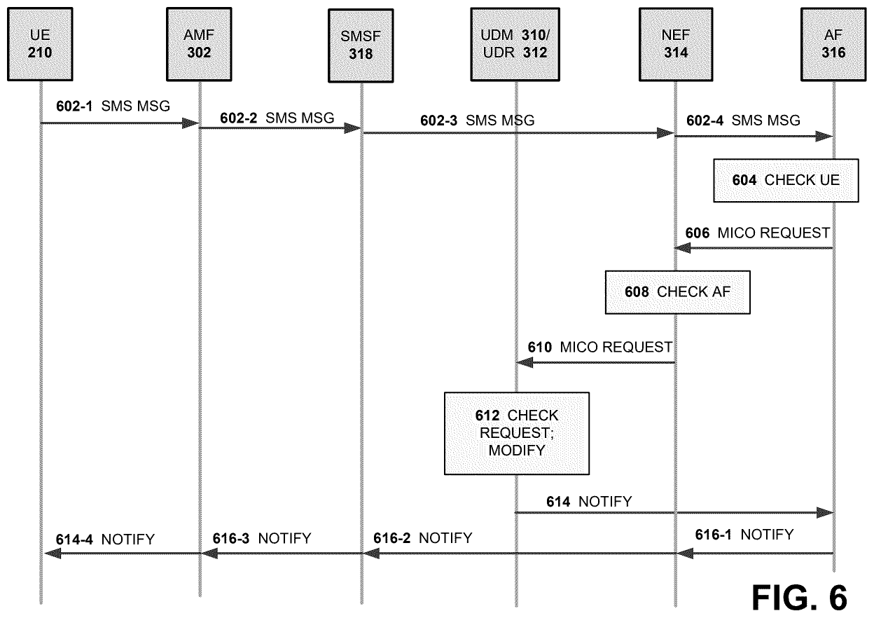

FIG. 5 is a flow diagram of an example process 500 that may be performed by components of system 100 for dynamic modification of MICO mode of UE 102, according to an implementation. FIG. 6 illustrates example messages that may be exchanged by the components of system 100 during process 500. Each block in FIG. 5 and FIG. 6 is not intended to signify every action performed by the components; and each arrow in FIG. 6 is not intended to indicate every message sent or received by the components.

As shown in FIG. 5, process 500 may include UE 102 detecting a triggering event (block 502). As described above, the triggering event may include an occurrence of an external event (e.g., a monitored parameter value reaching a threshold value), an internal event (e.g., battery power of the UE 102 reaching a threshold due to recharging or battery power of UE 102 falling below a threshold thus indicating a need to conserve power, an expiration of a timer, etc.), or receipt of input from a user of UE 102.

Process 500 may further include UE 102 sending an SMS message to AF 316 (block 504; arrows 602-1 through 602-4 in FIG. 6) and AF 316 receiving the message (block 504; arrow 602-4). For example, upon detecting the triggering event, in response, UE 102 may issue a request to switch to MICO mode or to non-MICO mode (if UE 102 is already in MICO mode). More specifically, for example, UE 102 may detect that its battery power has decreased and that it needs to conserve power Accordingly, UE 102 may send an SMS message to AF 316, requesting AF 316 to have network 104 operate in MICO mode for UE 102 (e.g., not initiate communications with UE 102). In another example, in response to detecting a monitored parameter reaching a critical threshold (e.g., temperature), UE 102 may send an SMS message to AF 316, requesting AF 316 to have network 104 operate in non-MICO mode for UE 102, so that a network component (e.g., AS 106 or AF 316) can query UE 102 to upload data to the network component at times selected by the network component. As further shown in FIG. 6, the SMS message from UE 102 may first reach AMF 302, which may then relay the message to SMSF 318. Next, SMSF 318 may further process the message and forward the SMS message to AF 316 via NEF 314.

Process 500 may further include AF 316 checking (or determining) whether UE 102 has the permission or the authority to request modification of the MICO parameter values (block 506; block 604). For example, when AF 316 receives the SMS message from UE 102, AF 316 may look up the ID of UE 102 which sent the SMS message in its AF MICO records 400. If a MICO record indicates that UE 102 has the permission to request the MICO parameter values to be modified, AF 316 may send a request to modify the MICO parameter to NEF 314 (block 508; arrow 606). For example, when AF 316 receives a request to change the mode of operation of UE 102 to MICO mode or non-MICO mode, AF 316 may look up, in MICO records 400, whether UE 102 has the permission to exit or enter MICO mode. If UE 102 has the permission, AF 316 may issue a request to change the MICO parameter to NEF 314.

Process 500 may further include, when NEF 314 receives the request to change the MICO parameter value from AF 316, NEF 314 checking if AF 316 has the permissions to change the MICO parameter values (block 510; block 608). For example, NEF 314 may look up the ID of AF 316 in its NEF MICO records 410. In some implementations, NEF MICO records 410 may also include IDs of UEs 102 whose MICO parameter values may be changed by AF 316, and in such implementations, NEF 314 may determine whether AF 316 not only has the general permission to change MICO parameter values, but those specific to particular UE 102 and/or particular MICO parameter values (e.g., DRX parameters). If no permission exists, NEF 314 may deny AF 316's request to modify the MICO parameter values.

Assuming that AF 316 has the permissions, process 500 may further include NEF 314 sending a request to modify MICO parameter values to UDR 312, on behalf of AF 316 (block 512; arrow 610). When UDR 312 receives the request from NEF 314, UDR 312 may consult UDR MICO records 420 to /heck/determine whether UE 102's MICO records may be modified (block 514; block 612), based on the permissions of UE 102 associated with the request. If so, UDR 312 may modify the MICO parameter values to the values indicated in the request (block 516; block 612). For example, if a request relayed by NEF 314 demands UE 102's status to be changed to MICO mode and UE 102 associated with the request has the permissions, UDR 312 may modify the MICO status of UE 102 to “YES”—indicating that network 104 may treat UE 102 as being in MICO mode. That is, with respect to UE 102, network 104 may enter “MICO mode” and thus not initiate communications with UE 102.

Process 500 may further include UDR 312 replying or notifying AF 316 via NEF 314, to indicate whether the MICO parameter values have been modified (block 516; arrow 614). When AF 316 receives a reply/notification from UDM 310/UDR 312, AF 316 may send a reply/notification to UE 102, via NEF 314, SMSF 318, and AMF 302 (bZlock 514; arrows 616-1 through 616-4), to indicate the change in the MICO parameter values at network 104. Details of the steps involved in sending the reply/notification may depend on whether UE 102 is in MICO mode and whether UE 102 is in connected state.

For example, if UE 102 is in MICO mode and is not in connected state, AF 316 may wait until UE 102 connects to network 104 (in accordance with the schedule stored in UDR 312) and then send an SMS message to AMF 302 via NEF 314 and SMSF 318. When AMF 302 receives the SMS message, AMF 302 may relay the SMS message to UE 102 over Non-Access Stratum (NAS). If UE 102 is in MICO mode and is already in connected state, AF 316 may reply/notify UE 102 immediately by sending the SMS message via NEF 314, SMSF 318, and AMF 302. If UE 102 is in non-MICO mode, AF 316 may page UE 102. Once UE 102 is in connected state, AF 316 may send the SMS message to UE 102 via NEF 314, SMSF 318, and AMF 302.

Once UE 102 receives the reply/notification from AMF 316, UE 102 may exit/enter MICO mode. If UE 102 enters MICO mode as a consequence of receiving the reply/notification, UE 102 may no longer accept network-initiated connection. Conversely, if UE 102 enters non-MICO mode, UE 102 may establish a network-initiated connection with network 104. In scenarios where the reply/notification merely indicates a MICO schedule change, UE 102 may modify the time window during which UE 102 connects to network 104. If the reply/notification indicates DRX parameter changes, UE 102 may change its DRX behavior during its connection to network 104.

FIG. 7 depicts exemplary components of a network device 700. Network device 700 may correspond to or be included in any of the devices and/or components illustrated in FIGS. 1-3 and 6 (e.g., network 104, UE 102, access network 204, core network 206, data network 208, access station 210, and core network components 302-318). In some implementations, network devices 700 may be part of a hardware network layer on top of which other network layers and NFs may be implemented.

As shown, network device 700 may include a processor 702, memory/storage 704, input component 706, output component 708, network interface 710, and communication path 712. In different implementations, network device 700 may include additional, fewer, different, or different arrangement of components than the ones illustrated in FIG. 7. For example, network device 700 may include line cards, switch fabrics, modems, etc.

Processor 702 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 700 and/or executing programs/instructions.

Memory/storage 704 may include static memory, such as read only memory (ROM), and/or dynamic memory, such as random access memory (RAM), or onboard cache, for storing data and machine-readable instructions (e.g., programs, scripts, etc.). Memory/storage 704 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 704 may be external to and/or removable from network device 700. Memory/storage 704 may include, for example, a Universal Serial Bus (USB) memory stick, a dongle, a hard disk, off-line storage, a Blu-Ray® disk (BD), etc. Memory/storage 704 may also include devices that can function both as a RAM-like component or persistent storage, such as Intel® Optane memories. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 706 and output component 708 may provide input and output from/to a user to/from network device 700. Input/output components 706 and 708 may include a display screen, a keyboard, a mouse, a speaker, a microphone, a camera, a DVD reader, USB lines, and/or other types of components for obtaining, from physical events or phenomena, to and/or from signals that pertain to network device 700.

Network interface 710 may include a transceiver (e.g., a transmitter and a receiver) for network device 710 to communicate with other devices and/or systems. For example, via network interface 710, network device 700 may communicate over a network, such as the Internet, an intranet, cellular, a terrestrial wireless network (e.g., a WLAN, WIFI, WIMAX, etc.), a satellite-based network, optical network, etc. Network interface 710 may include a modem, an Ethernet interface to a LAN, and/or an interface/connection for connecting network device 700 to other devices (e.g., a Bluetooth interface).

Communication path or bus 712 may provide an interface through which components of network device 700 can communicate with one another.

Network device 700 may perform the operations described herein in response to processor 702 executing software instructions stored in a non-transient computer-readable medium, such as memory/storage 704. The software instructions may be read into memory/storage 704 from another computer-readable medium or from another device via network interface 710. The software instructions stored in memory/storage 704, when executed by processor 702, may cause processor 702 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while series of actions, messages, and/or signals, have been described with reference to FIGS. 5 and 6, the order of the actions, messages, and signals may be modified in other implementations. In addition, non-dependent actions, messages, and signals may represent actions, messages, and signals that can be performed, sent, and/or received in parallel and in different orders. Furthermore, each of actions, messages, and signals illustrated may include one or more other actions, messages, and/or signals.

As used above, the term “session” may refer to a series of communications, of a limited duration, between two endpoints (e.g., two applications). When a session is established between an application and a network or a network slice, the session is established between the application and another application/server hosted by the network or the network slice. Similarly, if a session is established between a device and a network slice or a network, the session is established between an application on the device and another application on either the network slice or the network.

In addition, the term PDU session (a protocol data unit session) or a PDN session (packet data network session) may refer to communications between a mobile device and another endpoint (e.g., a data network, a network slice, etc.). Depending on the context, the term “session” may refer to a PDU session, a PDN session, or a session between applications. Additionally, depending on the context, the term “connection” may refer to a session, a PDU session, a PDN session, or another type of connection (e.g., a radio frequency link between a device and a base station).

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed IS:

1. A system comprising:
a network component configured to:
send, to a core network component, a request to modify a Mobile-Initiated Connection Only (MICO) parameter value, of a User Equipment device (UE), stored at a network;
receive, from the core network component, a reply that includes an indication regarding whether the MICO parameter value has been modified in accordance with the request; and
send a message that includes the indication.

2. The system of claim 1, wherein the message comprises a Short Message Service (SMS) message.

3. The system of claim 1, wherein the network component includes an Application Function (AF); and the core network component includes a Network Exposure Function (NEF).

4. The system of claim 3, wherein the NEF comprises:
data that indicates whether the network component is permitted to request the NEF to modify the MICO parameter value stored at the network.

5. The system of claim 1, further comprising a Unified Data Repository (UDR), wherein the UDR comprises:
data which indicates whether the UE is permitted to switch from MICO mode to non-MICO mode.

6. The system of claim 1, wherein the indication includes information which, when received by the UE, causes the UE to exit MICO mode.

7. The system of claim 1, wherein the network component is further configured to
detect a condition that triggers the network component to determine that the UE is to exit MICO mode.

8. The system of claim 1, wherein the network component is further configured to
receive, from the UE, a request to change the MICO parameter value, wherein the MICO parameter value indicates MICO mode for the UE; and
determine whether the UE is permitted to request the network component to modify the MICO parameter value stored at the network.

9. The system of claim 1, wherein the UE is configured to:
receive the message from the network component, and
exit MICO mode in response to receiving the message.

10. A method comprising:
sending, from a network component to a core network component, a request to modify a Mobile-Initiated Connection Only (MICO) parameter value, of a User Equipment device (UE), stored at a network;
receiving, from the core network component, a reply that includes an indication regarding whether the MICO parameter value has been modified in accordance with the request; and
sending a message that includes the indication.

11. The method of claim 10, wherein the message comprises a Short Message Service (SMS) message.

12. The method of claim 11, wherein the network component includes an Application Function (AF); and the core network component includes a Network Exposure Function (NEF).

13. . The method of claim 12, wherein the NEF comprises:
data that indicates whether the network component is permitted to request the NEF to modify the MICO parameter value stored at the network.

14. The method of claim 10, further comprising:
modifying data which indicates that the UE is in MICO mode.

15. The method of claim 10, wherein the indication includes information which, when received by the UE, causes the UE to exit MICO mode.

16. The method of claim 10, further comprising:
detecting a condition that triggers the network component to determine that the UE is to exit MICO mode.

17. The method of claim 10, further comprising:
receiving, from the UE, a request to change the MICO parameter value, wherein the MICO parameter value indicates MICO mode for the UE; and
determining whether the UE is permitted to request the network component to modify the MICO parameter value stored at the network.

18. The method of claim 10, further comprising:
receiving the message from the network component, and
exiting MICO mode in response to receiving the message.

19. A non-transitory computer-readable medium comprising processor-executable instructions, which, when executed by a processor, cause the processor to:
send, from a network component to a core network component, a request to modify a Mobile-Initiated Connection Only (MICO) parameter value, of a User Equipment device (UE), stored at a network;
receive, from the core network component, a reply that includes an indication regarding whether the MICO parameter value has been modified in accordance with the request; and
send a message that includes the indication.

20. The non-transitory computer-readable medium of claim 19, wherein the message comprises a Short Message Service (SMS) message.
